(19) United States
(12) Patent Application Publication
(10) Pub. No.: US 2025/0207627 A1
(43) Pub. Date: Jun. 26, 2025

(54) SPACER FOR ROTATING MEMBERS MOUNTED ON A DRIVE SHAFT

(71) Applicant: EBARA PUMPS EUROPE S.P.A., CLES (TRENTO) (IT)

(72) Inventors: Paolo BALZARIN, VIGASIO (VERONA) (IT); Stefano AVANZI, VERONA (VERONA) (IT); Fabrizio BENETTON, (MOLLARO) PREDAIA (TRENTO) (IT); Marco TROVI, TIRRENIA (PISA) (IT); Mariano MATTEAZZI, CLES (TRENTO) (IT)

(73) Assignee: EBARA PUMPS EUROPE S.P.A., CLES (TRENTO) (IT)

(21) Appl. No.: 18/846,578

(22) PCT Filed: Mar. 9, 2023
(86) PCT No.: PCT/EP2023/055999

§ 371 Date: Sep. 12, 2024

(30) Foreign Application Priority Data
Mar. 16, 2022 (IT) 102022000005111

(51) Int. Cl. F16C 3/02; F04D 17/12; F04D 29/053

(52) U.S. Cl. CPC F16C 3/02; F04D 17/12; F04D 29/053

(57) ABSTRACT

A spacer for rotating members mounted on a drive shaft has a substantially tubular body forming a seat for accommodating a drive shaft, the tubular body is made by bending a laminar body, made of rigid material, around a main axis of extension of the seat.

The present invention relates to a spacer for rotating members mounted on a drive shaft.

More particularly, the invention relates to a spacer for impellers mounted on the drive shaft of a centrifugal pump.

As is known, centrifugal pumps are fluid-dynamic machines used in many fields of technology to raise the pressure of a liquid.

Centrifugal pumps usually include one or more pumping stages, each having an impeller mounted on a drive shaft and rotating in the pump case.

In a multistage centrifugal pump, the stages are arranged in series so as to sequentially raise the pressure of the liquid that is conveyed mechanically from a suction port to a discharge port of the pump.

According to such configuration, the impellers are supported by the drive shaft and are mutually spaced by means of adapted spacers.

The known spacers are essentially constituted by a body having an almost tubular shape that forms two opposite abutment surfaces, one of which has a divergent shape, trumpet-like.

The commercially available spacers are not entirely satisfactory.

First of all, it should be considered that the plastic deformation required for forming the divergent abutment surface may compromise the structural integrity of the spacer.

Another drawback is that the two abutment surfaces are not perfectly parallel to each other and this affects the functionality of the rotating members.

From a production point of view, manufacturing such spacers is relatively laborious and consequently rather expensive.

CN212803607U discloses an immersed multistage centrifugal pump having a plurality of lower clamping blocks distributed in a circumferential array and integrally arranged at the lower end of an interstage sleeve; the impeller has a groove assembly used for being embedded into an upper clamping block or a lower clamping block.

U.S. Pat. No. 8,678,758B2 discloses an electrical submersible pump having a housing with a head and a base; a shaft arranged for rotation within the housing; an impeller stack that includes ceramic impellers mounted along the shaft; a diffuser stack that includes diffusers disposed within the housing; and a spring sleeve that includes axially spaced and overlapping tangential slots, the spring sleeve mounted along the shaft to apply a compressive force between the shaft and the impeller stack.

The aim of the present invention is to provide a spacer for rotating members mounted on a drive shaft that overcomes the drawbacks of the cited prior art.

Within the scope of the aim described above, a particular object of the invention is to provide a spacer that is safer and mechanically stronger.

A further object of the invention is to provide a spacer that has abutment surfaces that are perfectly parallel to each other.

A further object of the invention is to provide a spacer that is structurally simple yet highly effective and efficient in use.

This aim and these objects, as well as others which will become better apparent hereinafter, are achieved by a spacer for rotating members mounted on a drive shaft, as claimed in the appended claims.

Further characteristics and advantages will become better apparent from the description of preferred, but not exclusive, embodiments of a spacer according to the invention, illustrated by way of non-limiting example in the accompanying drawings, wherein:

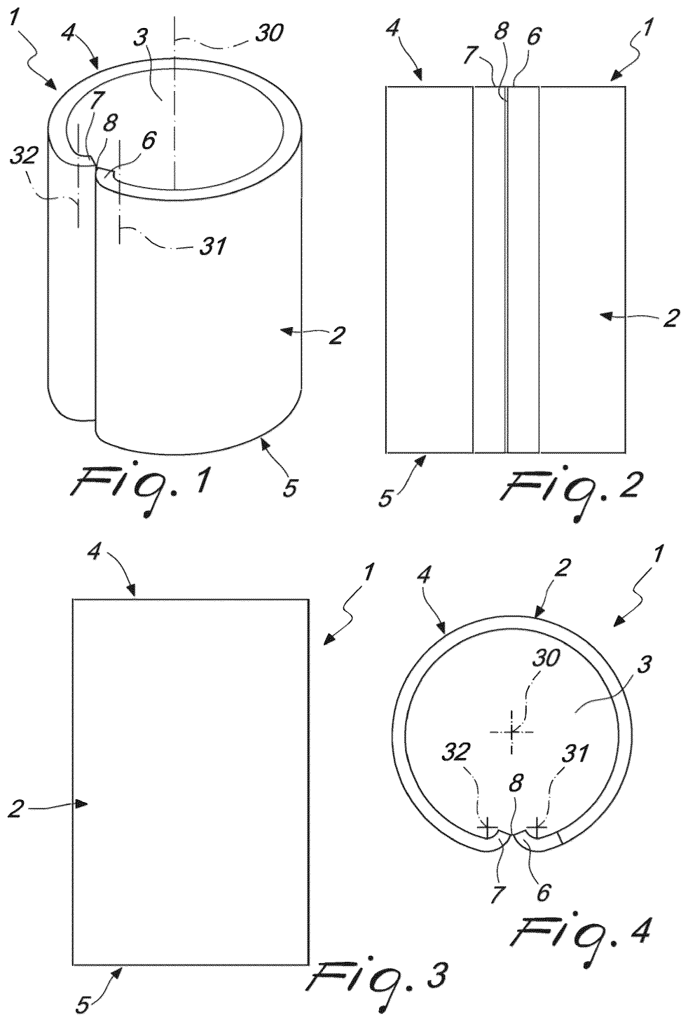

FIG. 1 is a perspective view of a spacer according to the invention;

FIG. 2 is a front view of the spacer according to the invention;

FIG. 3 is a side view of the spacer according to the invention;

FIG. 4 is a plan view of the spacer according to the invention;

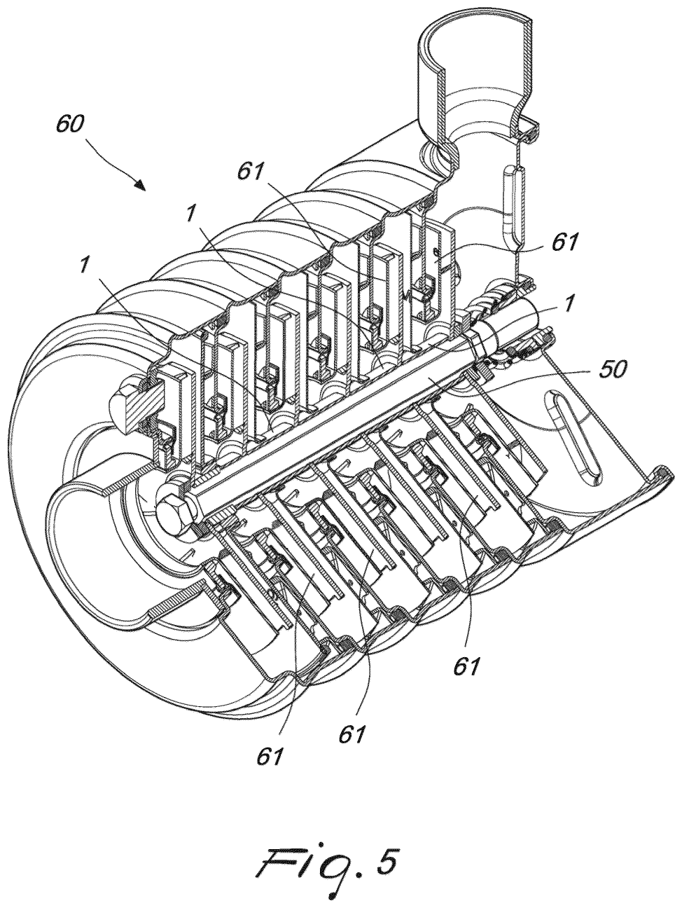

FIG. 5 is a partially sectional perspective view of a pump on which a spacer according to the invention is mounted;

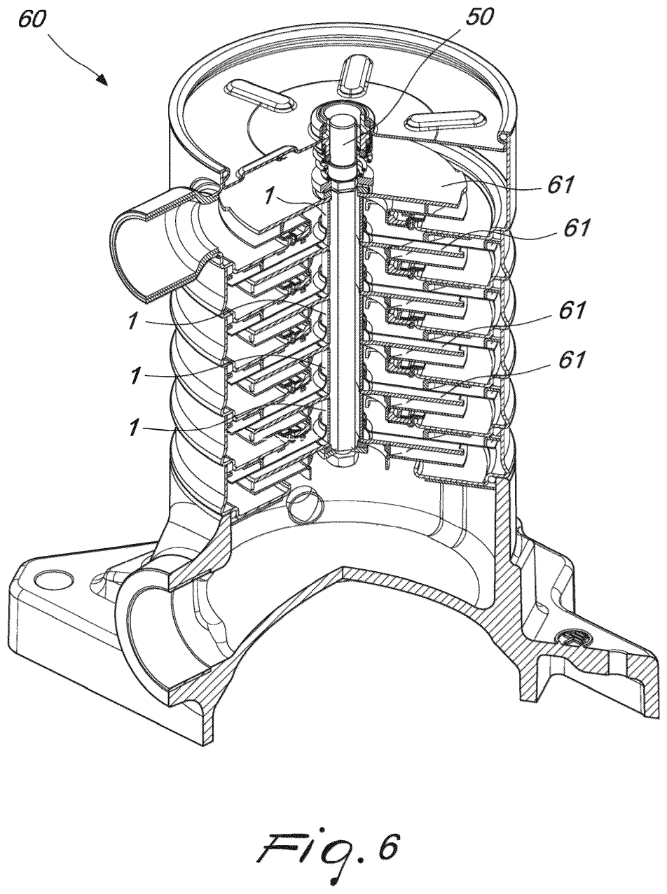

FIG. 6 is another partially sectional perspective view of a pump on which a spacer according to the invention is mounted;

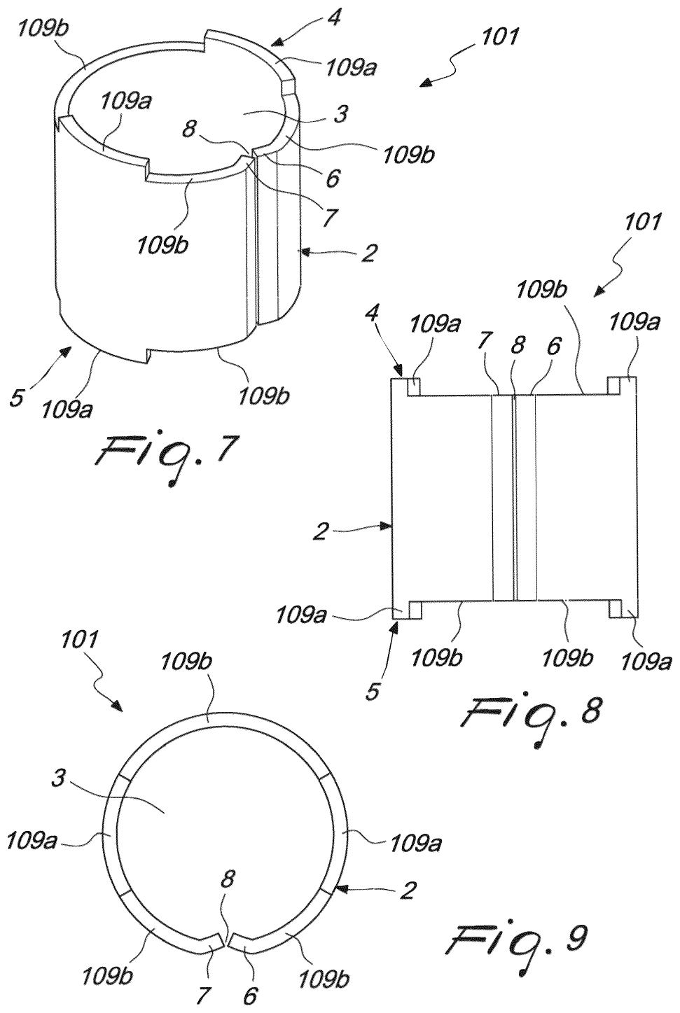

FIG. 7 is a perspective view of a spacer according to a further aspect of the invention;

FIG. 8 is a front view of the spacer of FIG. 7;

FIG. 9 is a plan view of the spacer of FIGS. 7 and 8;

FIG. 10 is a perspective view of a spacer according to a further aspect of the invention;

FIG. 11 is a front view of the spacer of FIG. 10;

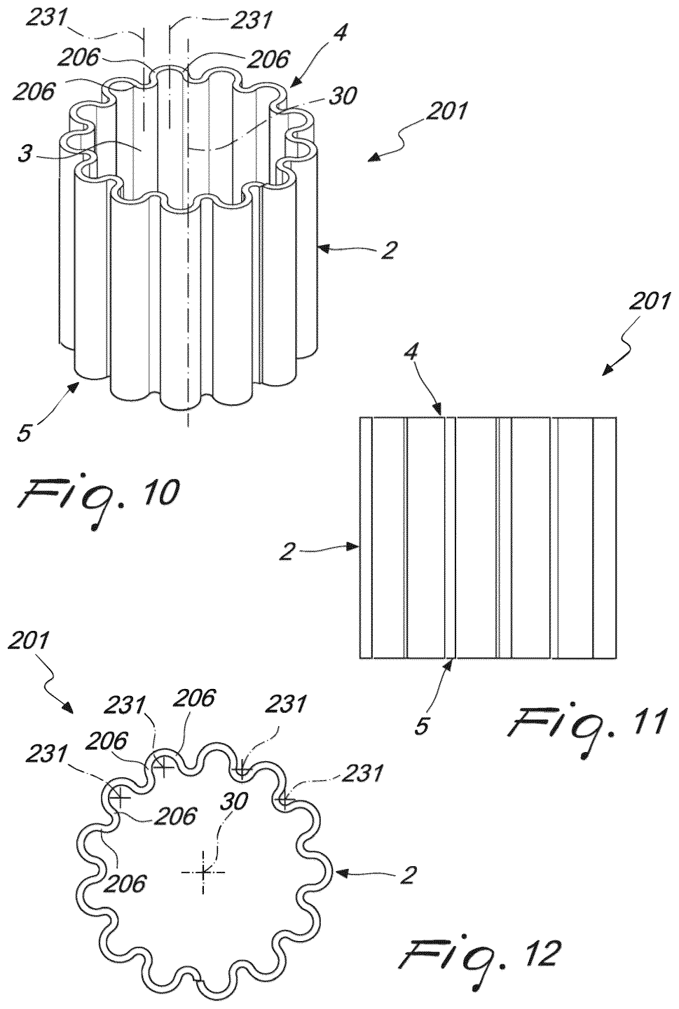

FIG. 12 is a plan view of the spacer of FIGS. 10 and 11.

With particular reference to FIGS. 1 to 6, a spacer according to the invention is generally designated by the reference numeral 1.

The spacer 1 is adapted to be mounted on the drive shaft 50 of a multistage centrifugal pump 60 where it is interposed between two adjacent impellers 61. The multistage centrifugal pump is per se known and will not be here described in detail.

According to the invention, the spacer 1 has a substantially tubular body 2 which forms a seat 3 of a drive shaft, namely shaft 50. The tubular body 2 is formed by bending a laminar body, made of rigid material, around a main axis 30 of the seat 3.

Preferably, the laminar body forming the body 2 has a substantially quadrangular shape and is made of metallic material, preferably stainless steel.

In this embodiment, the body 2 has a substantially circular sectional shape.

Alternatively, the body 2 may have an elliptical, polygonal, and/or mixtilinear cross-section.

The body 2 extends between two axial ends 4, 5 which form respective axial abutment surfaces, which are parallel to each other and perpendicular to the main axis 30.

Advantageously, the spacer 1 has at least a first bent-back portion 6, and preferably also a second bent-back portion 7, that extend substantially between the two axial ends 4, 5 of the body 2.

The first and second bent-back portions 6, 7 are formed integrally with the body 2 and are made by bending the laminar body respectively around a first bending axis 31 and a second bending axis 32 that are parallel to each other and are substantially parallel to the main axis 30.

The spacer 1 is constituted by a single part preferably having a cross-section with a substantially open profile, as shown for example in FIG. 4, made by bending the original laminar body around the main axis 30, the first bending axis 31 and the second bending axis 32, so as to provide the body 2 and monolithically also the first and second bent-back portions 6, 7.

In practice, the first and second bent-back portions 6, 7 are formed by bending two opposite edges of the laminar body from which the body 2 is made and therefore have an elongated and/or strip-like or band-like shape; preferably, they converge radially toward the main axis 30.

The first and second bent-back portions 6, 7 are located at the opposite edges of a slit 8 that extends between the two ends 4, 5 of the body 2, parallel to the main axis 30.

According to a further aspect of the invention, the bent-back portions may be located in any other point of the profile of the cross-section of the spacer.

The first and second bent-back portions 6, 7 undergo a plastic deformation during bending causing a work hardening of the first and second bent-back portions 6, 7 thereby improving the hardness and mechanical strength of the spacer 1.

Preferably the bending operation is a cold bending operation. However, also a hot bending operation may be used, with a subsequent material hardening and tempering treatment.

According to a further aspect of the invention, illustrated in FIGS. 7 to 9, the spacer, designated by the reference numeral 101, has at least one, but preferably both axial abutment surfaces formed by the two axial ends 4, 5 of the body 2 and having a shaped configuration.

Advantageously, this shaped configuration acts as an anti-rotational coupling between the spacer 101 and the rotating members between which it is interposed; in this example the rotating members are constituted by two impellers.

In this embodiment, the shaped configuration is made by a plurality of alternating raised portions 109a and recesses 109b.

According to a further aspect of the invention, shown in FIGS. 10 to 12, the spacer, designated here by the reference numeral 201, has a plurality of mutually blended bent-back portions 206 that extend substantially between the two axial ends 4, 5 of the body 2.

The bent-back portions 206 are formed integrally with the body 2 and are made by bending a laminar body around respective bending axes 231 that are parallel to each other and are substantially parallel to the main axis 30.

Each bent-back portion 206 is blended with the adjacent bent-back portion 206 in such a way that the transverse cross-section of the body 2 assumes an undulated profile, forming an alternating pattern of raised portions and recesses.

In the embodiments shown in FIGS. 7 to 12, the elements that correspond to the elements already described with reference to the embodiment shown in FIGS. 1 to 6 have been designated by the same reference numerals.

In practice it has been found that the invention achieves the intended aim and objects, offering a spacer which is greatly improved over the prior art spacers.

In fact, from what has been described above, it is clear that the spacer according to the invention is structurally simple and is easily manufactured. At the same time, the spacer according to the invention has stiffness and strength characteristics that are superior to those of the prior art spacers.

The spacer according to the invention is particularly versatile in terms of use and economy of processing, since, with a single tooling, by adjusting only the initial cutting dimensions of the laminar body, it is possible to manufacture spacers of different proportions.

The considerable simplification from the production standpoint also results in a significant decrease in production costs.

A further advantage of the spacer according to the invention is that its two abutment surfaces are perfectly parallel to each other, improving the functionality of the rotating members to which they are paired.

This application claims the priority of Italian Patent Application No. 102022000005111, filed on 16 Mar. 2022, the subject matter of which is incorporated herein by reference.

1-12. (canceled)

13. A spacer for rotating members mounted on a drive shaft, wherein, it comprises a substantially tubular body forming a seat for accommodating a drive shaft; said substantially tubular body being formed by bending a laminar body, made of rigid material, around a main axis of extension of said seat.

14. The spacer, according to claim 13, wherein it comprises at least a first bent-back portion that substantially extends between two axial ends of said substantially tubular body; said first bent-back portion being formed integrally with said substantially tubular body and being made by bending said laminar body around a first bending axis which is substantially parallel to said main axis.

15. The spacer, according to claim 13, wherein it comprises a second bent-back portion that substantially extends between said two axial ends of said substantially tubular body; said second bent-back portion being formed integrally with said substantially tubular body and being made by bending said laminar body around a second bending axis which is substantially parallel to said first bending axis and to said main axis.

16. The spacer, according to claim 13, wherein said first and second bent-back portions face each other on opposite sides of a gap that substantially extends between said two axial ends of said substantially tubular body.

17. The spacer, according to claim 13, wherein said first and second bent-back portions substantially converge toward said main axis.

18. The spacer, according to claim 13, wherein it comprises a plurality of bent-back portions that are mutually blended and substantially extend between said two axial ends of said substantially tubular body; said bent-back portions being formed integrally with said substantially tubular body and being made by bending said laminar body around respective bending axes that are parallel to each other and substantially parallel to said main axis.

19. The spacer, according to claim 13, wherein each of said bent-back portions of said plurality of bent-back portions is blended with the adjacent bent-back portion so as to give a transverse cross-section to said substantially tubular body; said transverse cross-section having an undulated profile, forming an alternating arrangement of protrusions and recesses.

20. The spacer, according to claim 13, wherein it comprises one or more regions of strain-hardened material that substantially extend at each bent-back portion.

21. The spacer, according to claim 13, wherein said two axial ends of said substantially tubular body form respective axial abutting surfaces which are mutually parallel.

22. The spacer, according to claim 13, wherein at least one of said axial abutment surfaces has a shape adapted to form an anti-rotational constraint between said spacer and the rotating members between which it is interposed.

23. The spacer, according to claim 13, wherein said substantially tubular body has a transverse cross-section with a substantially open profile.

24. The spacer, according to claim 13, wherein said laminar body has a substantially quadrangular shape.
